(19) United States
(12) Patent Application Publication
(10) Pub. No.: US 2011/0048621 A1
(43) Pub. Date: Mar. 3, 2011

(54) METHOD OF FORMING COMPOSITE OPTICAL FILM

(76) Inventors: Mikhail L. Pekurovsky, Bloomington, MN (US); Kristin L. Thunhorst, Stillwater, MN (US); Noreen G. Detwiler, Woodbury, MN (US); Olester Benson, JR., Woodbury, MN (US)

(21) Appl. No.: 12/666,888

(22) PCT Filed: Jun. 27, 2008
(86) PCT No.: PCT/US08/68476

§ 371 Date: Nov. 19, 2010

Related U.S. Application Data
(60) Provisional application No. 60/947,771, filed on Jul. 3, 2007.

(51) Int. Cl. B32B 37/14; B32B 37/15; B32B 37/20

(52) U.S. Cl. 156/191; 156/273.3; 156/273.5; 156/275.5

(57) ABSTRACT

Methods of forming composite optical film (100) are disclosed. The methods include exposing a composite film to a first energy source (340) to cure the composite film to (321) a first cure state. The composite film includes reinforcing (102) fibers dispersed within a curable resin (104). Then the method includes removing the first energy source from the first cure state composite film and then exposing the first cure state composite film to a second energy source (341) to further cure the composite film to a second cure state. The method includes 10 combining the composite film with an optical element to from the composite optical film.

### FIELD

The present disclosure relates to methods of forming composite optical film elements.

### BACKGROUND

Optical films, thin polymer films whose optical properties are important to their function, are often used in displays, for example, for managing the propagation of light from a light source to a display panel. Light management functions include increasing the brightness of the image and increasing the uniformity of illumination across the image.

Such films are thin and, therefore, generally have little structural integrity. As display systems increase in size, the area of the films also becomes larger. Unless they are made thicker, the films may reach a size where they are not sufficiently stiff to maintain their shape. This situation produces challenges for the production process during display assembly, as well as the use of the films in the display application. Making films thicker, however, increases the thickness of the display unit, and also leads to increases in the weight and in the optical absorption. The thicker films also increase thermal insulation, reducing the ability to transfer heat out of the display. Furthermore, there are continuing demands for displays with increased brightness, which means that more heat is generated with the display systems. This leads to an increase in the distorting effects that are associated with higher heating, for example film warping.

Currently, the solution to accommodate larger display sizes is to laminate the optical films to a much thicker substrate. This solution adds cost to the device, and makes the device thicker and heavier. The added cost does not, however, result in a significant improvement in the optical function of the display.

### BRIEF SUMMARY

The present disclosure relates to methods of forming composite optical film elements.

In a first embodiment, a method of forming a composite optical film is disclosed. The method includes forming a composite film includes exposing a composite film to a first energy source to cure the composite film to a first cure state, the composite film includes reinforcing fibers disposed within a curable resin. The method further includes removing the first energy source from the first cure state composite film, exposing the first cure state composite film to a second energy source to further cure the composite film to a second cure state, and then combining the composite film and an optical element to form a composite optical film.

In another embodiment, the method includes exposing a composite film to a first energy source to cure the composite film to a first cure state. The composite film includes reinforcing fibers dispersed within a curable resin. The reinforcing fibers have a first refractive index and the resin has a first cure state refractive index and the first cure state refractive index is at least a value of 0.004 different than the first refractive index. The method further includes removing the first energy source from the first cure state composite film and exposing the first cure state composite film to a second energy source to further cure the composite film to a second cure state where the resin has a second cure state refractive index value of less than 0.004 different than the first refractive index value.

### BRIEF DESCRIPTION OF THE DRAWINGS

The invention may be more completely understood in consideration of the following detailed description of various embodiments of the invention in connection with the accompanying drawings, in which:

FIG. 1 is a schematic perspective side view of an illustrative composite film element;

FIG. 2 is an schematic top view of an illustrative fibrous web;

FIG. 3 is a schematic side view of an illustrative apparatus for forming a first cure state composite film;

FIG. 4 and FIG. 5 illustrate further processing apparatus of the first cure state composite film to produce a second cure state composite film.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present invention. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to roll-to-roll manufacturing of composite optical films. The curable resin portion of the composite optical film is partially cured resulting in an essentially tack-free film that can be wound up for later processing or more completely cured, as desired and optionally combined with an optical element such as, for example, a light management optical film. In many embodiments, these composite optical films are transparent to at least one polarization of visible light wavelength. While the present invention is not so limited, an appreciation of various aspects of the invention will be gained through a discussion of the examples provided below.

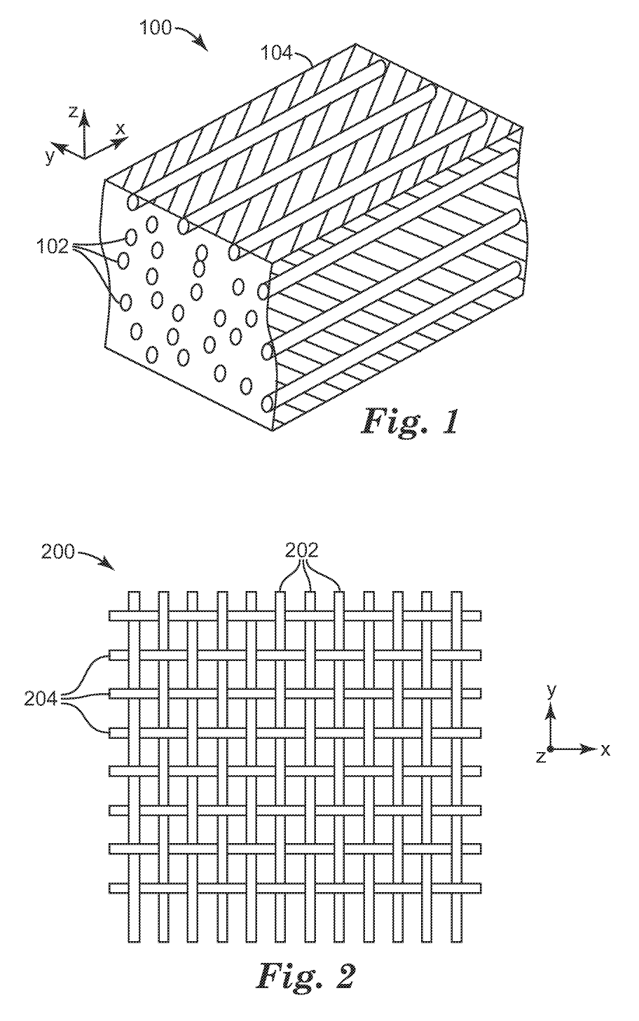

FIG. 1 is a schematic perspective side view of an illustrative composite film 100 showing the composite film 100 relative to an arbitrarily assigned coordinate system. The composite film 100 has a thickness in the z-direction. The composite film 100 includes reinforcing fibers 102 dispersed within a polymer or curable resin 104. The composite film 100 is formed as a bulk element, and may, for example be in the form of a sheet or film, a cylinder, a tube or the like. The composite film 100 may have a sufficient cross-sectional dimension that the composite film 100 is substantially self-supporting in at least one dimension.

Reinforcing fibers 102, such as organic fibers of polymeric material, or inorganic fibers of glass, glass-ceramic or ceramic, are disposed within the curable resin 104. Individual reinforcing fibers 102 may extend throughout the length of the composite film 100, although this is not a requirement. In the illustrated embodiment, the fibers 102 are lengthwise oriented parallel to the x-direction, although this need not be the case. The fibers 102 may be organized within the matrix 104 as a web of reinforcing fibers, as described below.

The refractive indices in the x-, y-, and z-directions for the material forming the curable resin matrix 104 are referred to herein as n₁ₓ, n_{1y} and n_{1z}. Where the resin material is isotropic, the x-, y-, and z-refractive indices are all substantially matched. Where the matrix material is birefringent, at least one of the x-, y- and z-refractive indices is different from the others. In some cases, only one refractive index is different from the others, in which case the material is called uniaxial, and in others all three refractive indices are different, in which case the material is called biaxial. In many embodiments, the material of the fibers 102 is isotropic. Accordingly, the refractive index of the material forming the fibers is given as n₂. In some embodiments, the reinforcing fibers 102 are birefringent.

In some embodiments, it may be desired that the resin matrix 104 be isotropic, i.e., n₁ₓ≈n_{1y}≈n_{1z}. To be considered isotropic, the differences among the refractive indices should be less than 0.05, or less than 0.02 or less than 0.01. Furthermore, in some embodiments it is desirable that the refractive indices of the matrix 104 and the fibers 102 be substantially matched. Thus, the refractive index difference between the matrix 104 and the fibers 102, should be small, at least less than 0.02, or less than 0.005, or less than 0.002. In other embodiments, it may be desired that the resin matrix 104 be birefringent, in which case at least one of the matrix refractive indices is different from the refractive index of the fibers 102.

Suitable materials for use in the curable resin matrix include thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, alkyl, aromatic, aliphatic, and ring-containing (meth)acrylates; ethoxylated and propoxylated(meth)acrylates; multifunctional (meth)acrylates; urethane (meth)acrylates; acrylated epoxies; epoxies; norbornenes; vinyl ethers, and other ethylenically unsaturated materials; thiol-ene systems; hybrid radical and cationic polymerizable systems such as epoxy and (meth)acrylates, and combinations of these. The term (meth)acrylate is defined as being either the corresponding methacrylate or acrylate compounds.

In some embodiments, it is advantageous to utilize polymeric materials as the reinforcing fibers. Example polymer materials include, but are not limited to, poly(carbonate) (PC); syndiotactic and isotactic poly(styrene) (PS); (C₁-C₈)alkyl styrenes; alkyl, aromatic, aliphatic and ring-containing (meth)acrylates, including poly(methylmethacrylate) (PMMA) and PMMA copolymers; ethoxylated and propoxylated(meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends.

In some product applications, the resulting products and components exhibit low levels of fugitive species (low molecular weight, unreacted, or unconverted molecules, dissolved water molecules, or reaction byproducts). Fugitive species can be absorbed from the end-use environment of the product, e.g. water molecules, can be present in the product from the initial product manufacturing, e.g. water, or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc. The fugitive species are generally lower molecular weight than the majority of the material forming the rest of the functional product. Product use conditions might, for example, result in thermal stress that is differentially greater on one side of the product or film. In these cases, the fugitive species can migrate through the product or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of the above polymers or resins may become birefringent when oriented. In particular, PET, PEN, and copolymers thereof, and liquid crystal polymers, manifest relatively large values of birefringence when oriented. Resins may be oriented using different methods, including extrusion and stretching. Stretching is a particularly useful method for orienting a polymer, because it permits a high degree of orientation and may be controlled by a number of easily controllable external parameters, such as temperature and stretch ratio.

Suitable curable resins or polymers include ethylenically unsaturated resin and a photoinitiator and/or a thermal initiator and/or a cationic initiator. If the curing is done with e-beam, or with thiol-ene type reactive systems, a separate initiator is not required.

The matrix 104 may be provided with various additives to provide desired properties to the composite film 100. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color long term. Other additives may be provided to the matrix 104 for altering the refractive index of the polymer or increasing the strength of the material. Such additives may include, for example, organic additives such as polymeric beads or particles and polymeric nanoparticles.

In other embodiments, inorganic additives may be added to the matrix 104 to adjust the refractive index of the matrix, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. These inorganic materials can be provided as nanoparticles, for example milled, powdered, bead, flake or particulate in form, and distributed within the matrix 104. The size of the particles can be less than 200 nm, or less then 100 nm, or less than 50 nm to reduce scattering of the light passing through the final film product.

The surfaces of these inorganic additives may be provided with a coupling agent for binding the fiber to the polymer. For example, a silane coupling agent may be used with an inorganic additive to bind the inorganic additive to the polymer. Although inorganic nanoparticles lacking polymerizable surface modification can be employed, the inorganic nanoparticles may be surface modified such that the nanoparticles are polymerizable with the organic component of the matrix. For example, a reactive group may be attached to the other end of the coupling agent. The group can chemically react, for example, through chemical polymerization via a double bond with the reacting polymer matrix.

FIG. 2 is a schematic top view of an illustrative reinforcing fiber forming a fibrous web 200. Any suitable type of organic or inorganic material may be used for the reinforcing fiber 102 forming the fibrous web 200. Illustrative fiber forming materials include glass fibers, carbon and/or graphite fibers, polymer fibers, boron fibers, ceramic fibers, glass-ceramic fibers, and silica fibers. In many embodiments, the fibers are formed into a fibrous web 200 as illustrated in FIG. 2.

The fiber 102 may be formed of an inorganic material such as, for example, a glass that is substantially transparent to the light passing through the film. Examples of suitable glasses include glasses often used in fiberglass composites such as E, C, A, S, R, and D glasses. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the resulting film becomes more stable for long term use. Furthermore, it may be desirable to use a low alkali glass, since alkali content in glass increases the absorption of water. The surfaces of these inorganic fibers may be provided with a coupling agent for binding the fiber to the polymer. For example, a silane coupling agent may be used with an inorganic fiber to bind the inorganic to the polymer.

Another type of inorganic material that may be used for the fiber 102 is a glass-ceramic material. Glass-ceramic materials generally include 95%-98% vol. of very small crystals, with a size smaller than one micrometer. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

Some ceramics also have crystal sizes that are sufficiently small that they can appear transparent if they are embedded in a matrix resin with an index of refraction appropriately matched. Ceramic fibers commercially available under the trade designation NEXTEL from 3M Company, St. Paul, Minn., are examples of this type of material, and are available as thread, yarn and woven mats.

Some exemplary arrangements of fibers within the matrix include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix may contain multiple layers of fibers: for example the matrix may include more layers of fibers in different tows, weaves or the like.

Organic fibers may also be embedded within the matrix 104 alone or along with the inorganic fibers. Some suitable organic fibers that may be included in the matrix include polymeric fibers, for example fibers formed of one or more of the polymeric materials listed above. Polymeric fibers may be formed of the same material as the matrix 104, or may be formed of a different polymeric material. Other suitable organic fibers may be formed of natural materials, for example cotton, silk or hemp. Some organic materials, such as polymers, may be optically isotropic or may be optically birefringent.

In some embodiments, the organic fibers may form part of a yarn, tow, weave and the like that contains only polymer fibers, e.g. a polymer fiber weave. In other embodiments, the organic fibers may form part of a yarn, tow, weave and the like that comprises both organic and inorganic fibers. For example, a yarn or a weave may include both inorganic and polymeric fibers. An embodiment of a fiber weave 200 is schematically illustrated in FIG. 2. The weave is formed by warp fibers 202 and weft fibers 204. The warp fibers 202 may be inorganic or organic fibers, and the weft fibers 204 may also be organic or inorganic fibers. Furthermore, the warp fibers 202 and the weft fibers 204 may each include both organic and inorganic fibers. The weave 200 may be a weave of individual fibers, tows, or may be a weave of yarn, or any combination of these.

In many embodiments, the woven fibrous web 200 is formed of glass fibers. In many embodiments, this glass fiber fabric 200 has a yarn count in a range from 25 to 100 yarns per inch along both the x- and y-axis, and a fabric weight in a range from 10 to 100 g/m², and a fabric thickness (z-axis) in a range from 15 to 100 micrometers. In many embodiments, the glass fibers forming each yarn in the glass fiber fabric 200 has a diameter in a range from 5 to 20 micrometers.

A yarn includes a number of fibers strung next to or twisted together. The fibers may run the entire length of the yarn, or the yarn may include staple fiber, where the lengths of individual fibers are shorter than the entire length of the yarn. Any suitable type of yarn may be used, including a conventional twisted yarn formed of fibers twisted about each other. Another embodiment of yarn is characterized by a number of fibers wrapped around a central fiber. The central fiber may be an inorganic fiber or an organic fiber.

In many embodiments, the fibers used to form the fibrous web 200 are below about 250 micrometers in diameter, and may have a diameter down to about 5 micrometers or less. Handling of small polymer fibers individually may be difficult. Using polymeric fibers in a mixed yarn, containing both polymer and inorganic fibers, however, provides for easier handling of the polymeric fibers since the yarn is less prone to being damaged by handling.

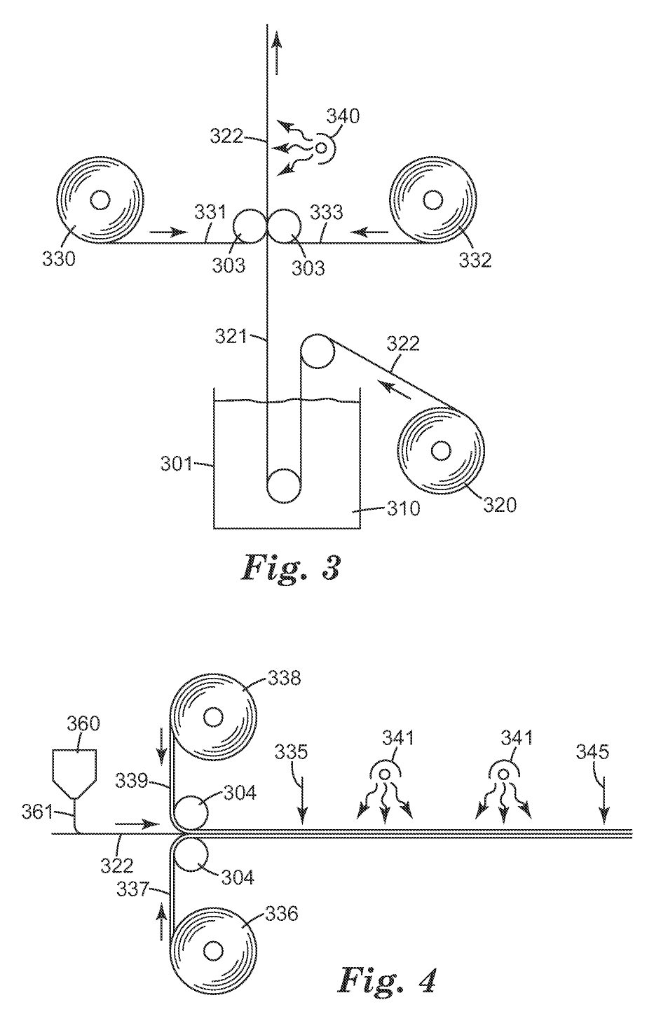

FIG. 3 is a schematic side view of an illustrative apparatus 300 for forming a composite film 322. The apparatus 300 includes a volume 310 of liquid curable resin, described above, and a roll 320 of fibrous web, described above, providing a layer of fibrous web to the volume 310 of resin, forming a resin impregnated fibrous web or composite film 321. The resin impregnated fibrous web or composite film 321 proceeds through nip rollers 303 and then is exposed to a first energy source or curing station 340 to cure the composite film to a first cure state 322. Once the composite film achieves the first cure state, the first energy source is removed from the partially cured composite film.

In many embodiments, one or more films 331, 333 are laminated onto one or both major surfaces of the composite film 322 as it proceeds through nip rollers 303 and then is exposed to a first energy source or curing station 340 to cure the composite film to a first cure state 322. Once the composite film achieves the first cure state, the first energy source is removed from the partially cured composite film. The films 331, 333 can be any useful film such as a polymeric backing film or an optical film (i.e., optical element). The films 331, 333 can be provided by film rolls 330, 332. In some embodiments, the film 331, 333 is a light control film for glare and reflection management, as described below.

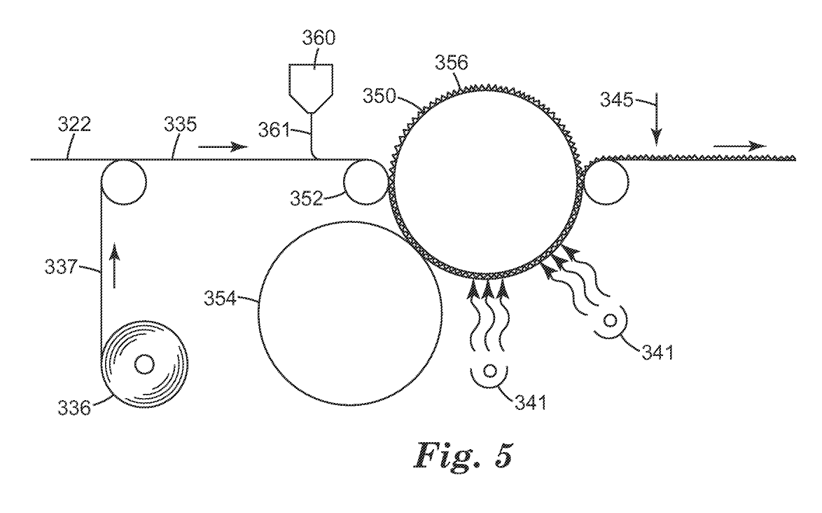

The reinforcing fibers have a first refractive index and the resin has a first cure state refractive index and the first cure state refractive index is at least a value of 0.004 different than the first refractive index, or at least a value of 0.01 different than the first refractive index. In many embodiments, light that propagates substantially perpendicularly through the first cure state composite film is subject to a bulk haze of 5% or greater, or 10% or greater. The first cure state composite film 322 is not fully cured, however, in many embodiments, the first cure state composite film 322 is not tacky and can be wound up on a roll for later processing or more completely cured by a subsequent exposure to a second radiation source (see FIG. 4 and FIG. 5). Upon further curing of to a second cure state (described below), the second cure state composite film 345 second cure state refractive index is a value less than 0.004, or even less than 0.002 different than the first refractive index. In many embodiments, light that propagates substantially perpendicularly through the second cure state composite film is subject to a bulk haze of 4% or less, or even 2% or less (being somewhat dependent on the fibrous web chosen). The second energy source or curing station 341 can be any useful curing energy source such as, for example, ultraviolet (UV), visible, infrared (IR), e-beam, or thermal. In many embodiments, the second energy source or curing station 341 is a radiation source such as a non-monochromatic UV source.

For certain surface structured films, especially brightness enhancing films, it is often desirable to limit the bulk diffusion (sometimes referred to bulk haze) that occurs within the film. Bulk diffusion is defined as the light scattering that takes place within the interior of an optical body (as opposed to light scattering occurring at the surface of the body). Bulk diffusion of a structured surface material can be measured by wetting out the structured surface (if the film has a structured surface) using index matching oils and measuring the haze using a standard haze-meter. Haze can be measured by many commercially available haze-meters and can be defined according to ASTM D1003. Limiting the bulk haze typically allows the structured surface to operate most efficiently in re-directing light, brightness enhancement, etc. For some embodiments of the current invention, it is desired that bulk haze is low. In particular, in some embodiments the bulk haze due to bulk diffusion (Bulk haze) may be less than 5%, in other embodiments less than 3% and in other embodiments less than 2%.

Bulk haze for the examples was measured by placing the (non-surface structured film) sample in the light path of a BYK Gardner Haze-Gard Plus (Cat. No. 4725) and the haze recorded. In this case, the bulk haze is defined as the fraction of light transmitted that is scattered outside an 8° cone divided by the total amount of light transmitted. The light is normally incident on the film. The representative examples included herein did not have a surface structure on them, so there was no need to apply index matching oils prior to placing the samples in the Haze-Gard Plus.

The measured values of bulk haze, i.e. the haze arising from propagation within the bulk of the polymer matrix, rather than from any diffusion occurring at the surface of the film, are shown in Table 4.

Monochromatic UV sources are understood to include, for example, Nichia UVLEDs with an emission spectrum primarily between 365 and 410 nm. The spectral distribution of light intensity in these systems occurs in a much narrower band of wavelengths than that produced by microwave-driven mercury-based lamps (such as Fusion H and D lamps from Fusion UV Systems Inc., Gaithersburg, Md.), and mercury arc lamp systems (such as those sold by Fusion Aetek, Romeoville, Ill.).

The resin described above can be partially cured to a first cure state as described above, and having a first cure state glass transition temperature that is lower than a more fully cured state or second cure state glass transition temperature. In many embodiments, the first cure state glass transition temperature is in a range from 15% to 75% of the final cure state or second cure state glass transition temperature. In some embodiments, the first cure state glass transition temperature is in a range from 15% to 50% of the final cure state or second cure state glass transition temperature. In some embodiments, the first cure state glass transition temperature is in a range from 25% to 70% of the final cure state or second cure state glass transition temperature. In some embodiments, the first cure state glass transition temperature is in a range from 30% to 65% of the final cure state or second cure state glass transition temperature. These ranges (and percentages) of glass transition temperature are dependent on, for instance, the ultimate glass transition temperature achievable in the polymerizing system if it were able to polymerize to the fullest extent of reaction possible (being not limited by temperature, etc.). It should be understood that these ranges are for illustrative purposes, and not intended to be limiting.

FIG. 4 and FIG. 5 illustrate further processing of the first cure state composite film 322 to produce a second cure state composite film 345. FIG. 4 illustrates forming a composite film 335 by disposing or laminating one or more films 337, 339 onto one or both major surfaces of the first cure state composite film 322 and then curing the composite film 335 to produce a second cure state composite film 345. The first cure state composite film 322 proceeds through nip rollers 304 with the one or more films 337, 339 onto one or both major surfaces, and then is exposed to a second energy source or curing station 341 to cure the composite film 335 to a second cure state 345.

FIG. 5 illustrates forming a composite film 335 by disposing or laminating one or more films 337 onto one or both major surfaces of the first cure state composite film 322, forming a structured surface on the composite film 335, and then curing the composite film 335 to produce a second cure state composite film 345.

In some embodiments, a coating dispenser 360 provides a liquid coating 361 onto the first cure state composite film 322. This liquid coating 361 can be formed of any useful material such as, for example, an adhesive material or resin materials described herein. The resin material can be the same or different than the resin material forming the composite film 321.

In some embodiments of FIG. 5, a roll of fibrous web 320 could be inserted in place of 322 and a liquid coating 361 can be applied from a liquid coating source 360. In that case, the curing station 341 could be the first energy source used to cure the resin to the first cure state while simultaneously producing a surface structure on the composite film. The liquid coating 361 could be the same (or a different) liquid curable resin as 310 in FIG. 3.

The films 331, 333, 337, 339 can be any useful film such as a polymeric backing film or an optical film (i.e., optical element). The films 331, 333, 337, 339 can be provided by film rolls 330, 332, 336, 338. In some embodiments, the film 331, 333, 337, 339 is a light control film for glare and reflection management. These films 331, 333, 337, 339 include light polarizer films, light redirecting films, multilayer reflective polarizing films, absorbing polarizer films, prismatic brightness enhancement films, diffuser films, light reflective films, reflective polarizer brightness enhancement films, and turning films. These films 331, 333, 337, 339 can be a structured surface film such as Brightness Enhancement Film (BEF) to provide brightness enhancement, or other films including reflective polarizers including interference type, blend polarizers, wire grid polarizers, cholesteric liquid crystal polarizers; other structured surfaces including turning films, retroreflective cube corner films; diffusers such as surface diffusers, gain diffuser structured surfaces, or structured bulk diffusers; antireflection layers, hard coat layers, stain resistant hard coat layers, louvered films, absorptive polarizers, partial reflectors, transreflective films, asymmetric reflectors or polarizers, wavelength selective filters, films having localized optical or physical light transmission regions including perforated mirrors; compensation films, birefringent or isotropic monolayers or blends, as well as bead coatings. For example, a list of additional coatings or layers is discussed in further detail in U.S. Pat. Nos. 6,459,514 and 6,827,886, the contents of which are both herein incorporated by reference in their entirety.

The composite film 335 is then further cured via exposing the first cure state composite film 322 or 335 to a second energy source 341. As illustrated in FIG. 5, the composite film 322 or 335 and/or optional liquid coating layer 361, may be molded or shaped prior to further curing, or while being cured. For example, the film 322 or 335 and/or the optional liquid coating layer 361 may be molded to provide a structured surface or a light redirecting surface. The film 322 can combined with a backing layer or optical film element 337, described above, to form a composite film 335 and then guided to a molding roll 350 by a guiding roll 352 and may be pressed against the molding roll 350 by an optional pressure roll 354. The molding roll 350 has a shaped surface 356 that is impressed into the composite film 322 or 335 and/or the optional liquid coating layer 361. The spacing between the molding roll 350 and the pressure roll 354 may be adjusted to a set distance that controls the depth of penetration of the shaped surface 356 into the composite film 322 or 335 and/or the optional liquid coating layer 361. In some embodiments, the composite film 322 or 335 and/or the optional liquid coating layer 361 is cured while still in contact with the molding roll 350 by irradiation with UV light or heat from an energy source 341 to form a second state cured composite film 345.

The second state cured composite film 345 may be stored on another roll or cut into sheets for storage. Optionally, the second state cured composite film 345 may be further processed, for example through the addition of one or more layers.

### Examples

### Preparation of the Polymerizable or Curable Resin

A mixture of polymerizable resins was created comprising 74.81 weight % of SR601 from Sartomer Company (Exton, Pa.), 0.25 weight % TPO from BASF Corporation (Charlotte, N.C.), 12.47 weight % SR247 from Sartomer Company, and 12.47 weight % TO-1463 from Toagosei America (West Jefferson, Ohio). The resin was placed into an open tray and heated to approximately 41 degrees centigrade. The tray of resin was heated via a water bath heat exchanger to maintain the polymerizable resin in the tray at 41 degrees centigrade. The same resin was used for Examples 1-8.

Preparation of Saturated Fiberglass

Approximately 75 lineal yards of fiberglass fabric (Style 1080 with CS-767 surface finish from Hexcel Reinforcements Corporation, Anderson, S.C.) was wound onto a paperboard core. The core with the wound fiberglass fabric on it was rotated continuously and approximately ⅙ of the diameter of the roll was submerged into the bath of polymerizable resin and rotated for approximately 60 minutes. During this time, the fabric became saturated with the warm polymerizable resin, and most of the air bubbles in the fiberglass fabric were displaced by, and/or dissolved into, the warm polymerizable resin. The same roll of saturated fiberglass was used to generate Examples 1-8.

Metering of the Polymerizable Resin

The wound roll of fiberglass saturated with polymerizable resin was placed onto an unwind spindle of a coating machine. The glass was unwound and routed through a tank of additional polymerizable resin (at ambient temperature and pressure). The saturated fiberglass exited the tank in a vertical manner and passed through a nip consisting of one rubber roll (85 durometer rubber) and one smooth steel roll. Into the nip, two layers of 0.005 inch thick PET were added (Dupont Melinex® 618 PET film, Dupont Teijin Films US Limited Partnership, Hopewell, Va.). The Melinex® 618 has been treated on one side to promote adhesion, so the un-treated side was placed into contact with the saturated fiberglass. Thus, when the films passed through the nip, the arrangement was as follows: rubber roll, PET, saturated fiberglass, PET, and finally, the steel roll. Approximately 1 kg force/cm² was applied to the nip to meter the polymerizable resin to the desired thickness. The excess resin drained downward from the nip, back into the tank containing additional polymerizable resin. Leaving the nip vertically was a film construction containing the following layers in this order: PET, saturated fiberglass, and PET. The speed at which the saturated fiberglass was advanced through the coating machine was 2 meters per minute.

Polymerizing the Polymerizable Resin to a First Cure State, and a Second Cure State

The film construction containing the saturated fiberglass was exposed to an array of LEDs emitting UV light. The UVLEDs were purchased from Nichia (Tokyo, Japan) and mounted into an array of 4 rows by 40 columns of LEDs. The spectral output for these LEDs peaked around 385 nm with a narrow spectral distribution from approximately 365 nm to 410 nm. The LED array was supplied with 34.6 to 39 Volts of power to supply between 2.5 and 7.34 Amps of current through the LEDs. The varying current provided a variety of UV dose measurements cited in Table 1. The UV light penetrated the PET films and cured the polymerizable resin within the fiberglass fabric. After curing the polymerizable resin, the samples were either removed from exposure to the UVLEDs or passed under a UV arc lamp system purchased from Fusion Aetek (Part number 19031D, Romeoville, Ill.). Regardless of whether the UVLEDs alone, or the UVLEDs and the Fusion Aetek arc lamp were used to induce the polymerization of the resin, the speed that the film was advanced through the UV source(s) was 2 meters per minute. In the cases in which the Fusion Aetek arc lamp was used, only one arc lamp on low power was used to cure the samples. Radiometric measurements are included in Tables 1 and 2 for both the UVLEDs and the Fusion Aetek arc lamp. The radiometric measurements were completed on the Arc lamp with a Power Puck that had recently been calibrated (EIT Inc., Sterling, Va.), at a linespeed of 6.096 meters/min and the dose was subsequently calculated for the 2 meters per minute process speed (and reported in Table 2). Radiometric measurements for the UVLEDs were completed with an IL 1700 Research Radiometer (International Light, Peabody, Mass.) with SED005 detector and a “W” diffuser, with the 380-nm calibration factor.

TABLE 1
UV Dose Measurements for the Nichia UVLED array and list of
Examples, line speed = 2 meters/min for calculated dose.

| Voltage of UVLED | Amperage | UVA Dose |
|---|---|---|
| power supply | through LEDs | (mJ/cm\hat{ }2) |
| 34.6 | 2.5 | 34.6 |
| 36 | 3.5 | 45.7 |
| 37.4 | 5 | 54.9 |
| 39 | 7.34 | 87.2 |

TABLE 2
UV Dose Measurements for the Fusion Aetek arc lamp (one lamp, low
power setting), line speed = 2 meters/min for calculated dose

| | Dose | Intensity |
|---|---|---|
| UV Channel | (mJ/cm\hat{ }2) | (mW/cm\hat{ }2) |
| UVA | 959 | 561 |
| UVB | 807 | 470 |
| UVC | 110 | 68 |
| UVV | 543 | 532 |

After the samples were polymerized, the PET liners were removed and the sample properties were measured.

Sample Characterization:

The sample cured refractive index was measured on a Metricon. (Metricon Corporation, Pennington, N.J. Model # 2010 measured at 633 nm). Three measurements were taken on every sample, and the average is reported.

The thickness of the samples was measured with a Mitutoyo caliper gauge (Mitutoyo Corp., Japan, Model # ID-C112EB code # 543-252B). Three thickness measurements were taken across the sample, and the average is reported.

The first refractive index of the fiberglass fabric was inferred by the following procedure:

Seventeen distinct polymerizable resins with individual cured refractive index values between 1.546 and 1.559 were prepared, saturated into the Hexcel 1080 fiberglass fabric, and cured. The haze values of the resulting composite films were measured using the BYK Gardner HazeGard Plus (Columbia, Md.). The point of the minimum in the haze vs. cured refractive index graph was chosen as the first refractive index of the fiberglass fabric. By this method, the Hexcel 1080 glass fabric first refractive index was determined to be 1.5575.

The bulk haze and the transmission of the sample were measured with a BYK Gardner HazeGard Plus (Cat. No. 4725). Three individual measurements were taken on every sample, and the average is reported.

The storage modulus and glass transition temperature of the film samples were measured using a TA Instruments Q800 series Dynamic Mechanical Analyzer (DMA) (New Castle, Del.) with film tension geometry. Temperature sweep experiments were performed in dynamic strain mode over the range of −40° C. up to 100° C. at 2° C./min. The storage modulus and tan delta (loss factor) were reported as a function of temperature. The peak of the tan delta versus temperature curve was used to identify the glass transition temperature, Tg, for the films. The measurements were completed in the machine direction (warp fiber direction) of the composite samples. Two measurements were completed on each sample and the average is reported.

TABLE 3
Exposure Dose from UVLEDs and Arc Lamp for Examples

| Example | UVLED Dose | Arc Lamp UVA | Arc Lamp UVB | Arc Lamp UVC | Arc Lamp UVV |
|---|---|---|---|---|---|
| Number | (mJ/cm\hat{ }2) | Dose (mJ/cm\hat{ }2) | Dose (mJ/cm\hat{ }2) | Dose (mJ/cm\hat{ }2) | Dose (mJ/cm\hat{ }2) |
| 1 | 34.6 | 0 | 0 | 0 | 0 |
| 2 | 45.7 | 0 | 0 | 0 | 0 |
| 3 | 54.9 | 0 | 0 | 0 | 0 |
| 4 | 87.2 | 0 | 0 | 0 | 0 |
| 5 | 34.6 | 959 | 807 | 110 | 543 |
| 6 | 45.7 | 959 | 807 | 110 | 543 |
| 7 | 54.9 | 959 | 807 | 110 | 543 |
| 8 | 87.2 | 959 | 807 | 110 | 543 |

TABLE 4
Results of Examples and characterization

| | Avg. | | | Fiberglass RI | | Avg. | |
|---|---|---|---|---|---|---|---|
| Example | Thickness | Avg. Modulus | Avg Tg | minus avg. | Avg. | transmission | Avg. haze |
| Number | (mils) | at 25 C. (MPa) | (deg C.) | cured resin RI | Cured RI | (%) | (%) |
| 1 | 2.10 | 15914 | 14 | 0.0087 | 1.5488 | 93.33 | 9.54 |
| 2 | 1.93 | 14298 | 21 | 0.0069 | 1.5506 | 93.30 | 3.62 |
| 3 | 1.90 | 16941 | 26 | 0.0058 | 1.5517 | 93.50 | 3.25 |
| 4 | 1.90 | 16796 | 32 | 0.0046 | 1.5529 | 93.40 | 3.38 |
| 5 | 1.95 | 18551 | 48 | 0.0018 | 1.5557 | 93.30 | 3.50 |
| 6 | 2.07 | 19514 | 50 | 0.0014 | 1.5561 | 93.23 | 3.80 |
| 7 | 2.10 | 18924 | 48 | 0.0014 | 1.5561 | 93.30 | 3.77 |
| 8 | 1.93 | 18314 | 47 | 0.0017 | 1.5558 | 93.30 | 3.77 |

The data in Table 4 illustrate a trend of increasing glass transition temperature in the UVLED cured samples (Examples 1-4) as the light dose increased. When light dose (and heat) from the arc lamp was added to these samples (for Examples 5-8), the glass transition temperatures of the polymerized samples increased to approximately 50 degrees centigrade. The maximum glass transition temperature achieved in the first cure state (created with UVLEDs) is dependent on the resin chosen, and the temperature achieved by the resin during the polymerization. In Examples 1-4, the glass transition temperature reached in the first cure state was between 29 and 64% of the final glass transition temperature reached in the second cure state. In other illustrative examples not specifically shown here, glass transition temperatures as low as 15% of the final glass transition temperatures were reached.

Samples that were illuminated with the same light dose from the UVLEDs display an increase in modulus ranging from 1500 to 5250 MPa when exposed to the additional light of the arc lamp.

Also evident from the data in Table 4, the cured refractive index increases as the samples received increasing light dose from the UVLEDs. Samples that were illuminated with UVLED and then subsequently with the arc lamp illustrate that a plateau is reached in the cured refractive index (at approximately 1.5560), regardless of the amount of light initially received in the UVLED portion of the curing process. As the refractive increases during curing with the UVLEDs, the resin index becomes in closer to the value of the first refractive index of the fiberglass fabric (the difference between the fiberglass RI and the cured resin RI decreases). The UVLED cured samples (Examples 1-4) illustrate that the difference between the partially polymerized resin refractive index and that of the fiberglass fabric is greater than 0.004 in all cases. For the samples that are cured with both UVLED and subsequently with the arc lamps (Examples 5-8), the maximum difference between the fiberglass refractive index and the fully polymerized resin refractive index is less than 0.002 in all cases.

The average haze value of the partially polymerized samples illustrates a dramatic increase in haze when the difference between the fiberglass refractive index and the partially polymerized resin index exceeds 0.007 (Example 1). In this case, the bulk haze value of the sample exceeded 5%. This observation is consistent with other illustrative examples not specifically shown here in which haze values of 14% were reported for partially polymerized samples with a difference between the fiberglass refractive index and the partially polymerized resin refractive index exceeding 0.007. As the refractive index of the partially polymerized resin becomes more closely matched to that of the fiberglass, the bulk haze decreases. For all the samples that were completely polymerized through exposure to the arc lamp after the UVLEDs (Examples 5-8), the bulk haze value was less than 4%. The value of the minimum bulk haze achieved in a composite film is a function of the reinforcing fibrous web (and any coatings/finishing agents/binders applied to that fibrous web) chosen. In other illustrative examples not shown here, bulk haze values of less than 2% were achieved in the fully cured composite article.

Thus, embodiments of the METHODS OF FORMING COMPOSITE OPTICAL FILM are disclosed. One skilled in the art will appreciate that the present invention can be practiced with embodiments other than those disclosed. The disclosed embodiments are presented for purposes of illustration and not limitation, and the present invention is limited only by the claims that follow.

1. A method of forming a composite optical film, comprising:
exposing a composite film to a first energy source to cure the composite film to a first cure state, the composite film comprising reinforcing fibers dispersed within a curable resin;
removing the first energy source from the first cure state composite film;
exposing the first cure state composite film to a second energy source to further cure the composite film to a second cure state; and
combining the composite film with an optical element to form a composite optical film.

2. A method according to claim 1, wherein the combining step occurs before the exposing a composite film to a first energy source step.

3. A method according to claim 1, wherein the combining step occurs before the exposing the first cure state composite film to a second energy source step and after the exposing a composite film to a first energy source step.

4. A method according to claim 1, wherein the combining step occurs after the exposing the first cure state composite film to a second energy source step.

5. A method according to claim 1, wherein the optical element is a light polarizing film.

6. A method according to claim 1, wherein the optical element is a light redirecting film.

7. A method according to claim 1, wherein the optical element is a multilayer reflective polarizing film.

8. A method according to claim 1, wherein the optical element is an absorbing polarizing film.

9. A method according to claim 1, further comprising forming three dimensional structure on a surface of the composite film by contacting the surface of the composite film against a three dimensional structure forming tool.

10. A method according to claim 9, wherein the structure on the surface of the composite film comprises a plurality of light redirecting structures.

11. A method according to claim 1, wherein the reinforcing fibers form a woven layer of fibers.

12. A method according to claim 1, wherein light that propagates substantially perpendicularly through the first cure state composite film is subject to a bulk haze value of 5% or greater and light that propagates substantially perpendicularly through the second cure state composite film is subject to a bulk haze of less than 5%.

13. A method according to claim 1, wherein the curable resin has a first cure state glass transition temperature and a second sure state glass transition temperature and the first cure state glass transition temperature is in a range from 15% to 75% of the second cure state glass transition.

14. A method according to claim 1, wherein the reinforcing fibers have a first refractive index and a refractive index of the first cure state is at least a value of 0.004 different than the first refractive index, and a refractive index of the second cure state is less a value that is less than 0.004 different than the first refractive index value.

15. A method according to claim 1, wherein the first energy source is a monochromatic energy source.

16. A method according to claim 1, wherein the second energy source is an ultraviolet light energy source.

17. A method according to claim 1, wherein the first energy source emits a first light spectrum and the second energy emits a second light spectrum and the first light spectrum is different that the second light spectrum.

18. A method according to claim 1, further comprising winding the first cure state composite film onto a roll and then unwinding the first cure state composite film from the roll before exposing the first cure state composite film to a second energy source to further cure the composite film to a second cure state.
